(19) United States
(12) Patent Application Publication
(10) Pub. No.: US 2009/0284152 A1
(43) Pub. Date: Nov. 19, 2009

(54) PLASMA DISPLAY PANEL

(76) Inventors: Sang-Hun JANG, Suwon-si (KR); Shinichiro NAGANO, Suwon-si (KR); Chung-Gyoo LEE, Suwon-si (KR); Yong-Shik HWANG, Suwon-si (KR); Seong-Chan BAE, Suwon-si (KR); Jae-Wook KANG, Suwon-si (KR); Hyeon-Seok KIM, Suwon-si (KR); Hyun-Jung LEE, Suwon-si (KR); Yong-Mi YU, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/453,466

(22) Filed: May 12, 2009

(30) Foreign Application Priority Data
May 13, 2008 (KR) 10-2008-0043951

(51) Int. Cl. H01J 17/49

(52) U.S. Cl. 313/582

(57) ABSTRACT

A plasma display panel, including a front substrate and a rear substrate arranged opposite to each other, a plurality of display electrodes disposed in a first direction on a first surface of the front substrate, a dielectric layer covering the display electrodes on the front substrate, a protective layer including protective layer grains covering the dielectric layer, and a crystal modification seed layer disposed between the dielectric layer and the protective layer, wherein the crystal modification seed layer includes crystal modification seeds including at least one of an alkaline earth metal, a transition metal, an amphoteric element, a semimetal element, and a lanthanide.

### BACKGROUND

1. Technical Field

Embodiments relate to a plasma display panel.

2. Description of the Related Art

A plasma display panel (PDP) is a display device that forms an image by exciting a phosphor with vacuum ultraviolet (VUV) rays generated by gas discharge in discharge cells. Since a PDP may be capable of realizing a large high-resolution screen, it is drawing attention as a next-generation thin display device.

A three-electrode surface-discharge PDP has been widely used. The three-electrode surface-discharge PDP may include a front substrate and a rear substrate. Display electrodes including a pair of electrodes may be disposed on the front substrate and covered by a dielectric layer. Address electrodes may be disposed on the rear substrate. A space between the front substrate and the rear substrate may be partitioned by barrier-ribs into a plurality of discharge cells, which may be filled with a discharge gas. A phosphor layer may be disposed on the rear substrate.

The electrodes, the barrier ribs, and the dielectric layer may generally be formed using a printing process due to economical reasons. Thus, the layers may be thick and of poor quality despite a thin film forming process.

Therefore, in an AC plasma display element, sputtering of ions and electrons generated from the discharge may damage the dielectric layer and an electrode under the dielectric layer, and thereby shorten the life-span of the PDP. To reduce the influence of the ion impact during discharge, a protective layer as thin as hundreds of nanometers (nm) may be formed on the dielectric layer. Generally, the protective layer may be formed of MgO. The MgO protective layer may reduce discharge voltage and protect the dielectric layer from sputtering to thereby lengthen the life-span of the plasma display element.

Since the protective layer may have widely various characteristics depending upon layer-forming conditions, e.g., a heating disposition process, it may be difficult to maintain display quality within a certain level. The protective layer may cause black noise due to an address discharge delay, which is an address miss wherein light is not emitted in a selected cell. The black noise may generally occur at a boundary between a light-emitting region and non-light-emitting region, but may occur at other regions. The address miss may occur at a low intensity when there is no address discharge, or even when a scan discharge has progressed. Accordingly, it is desirable to diminish the address discharge delay time to prevent black noise and the address miss.

### SUMMARY

Embodiments are therefore directed to a plasma display panel, which substantially overcomes one or more of the problems due to the limitations and disadvantages of the related art.

It is therefore a feature of an embodiment to provide a plasma display panel with improved efficiency and discharge delay characteristics.

At least one of the above and other features and advantages may be realized by providing a plasma display panel including a front substrate and a rear substrate arranged opposite to each other, a plurality of display electrodes disposed in a first direction on a first surface of the front substrate, a dielectric layer covering the display electrodes on the front substrate, a protective layer including protective layer grains covering the dielectric layer, and a crystal modification seed layer disposed between the dielectric layer and the protective layer, wherein the crystal modification seed layer includes crystal modification seeds including at least one of an alkaline earth metal, a transition metal, an amphoteric element, a semimetal element, and a lanthanide.

The crystal modification seeds may include at least one of a carbonate salt of at least one of an alkaline earth metal, a transition metal, an amphoteric element, a semimetal element, and a lanthanide a sulfate of at least one of an alkaline earth metal, a transition metal, an amphoteric element, a semimetal element, and a lanthanide, a carbide of at least one of an alkaline earth metal, a transition metal, an amphoteric element, a semimetal element, and a lanthanide, a nitride of at least one of an alkaline earth metal, a transition metal, an amphoteric element, a semimetal element, and a lanthanide, a fluoride of at least one of an alkaline earth metal, a transition metal, an amphoteric element, a semimetal element, and a lanthanide, or an oxide of at least one of an alkaline earth metal, a transition metal, an amphoteric element, a semimetal element, and a lanthanide.

The crystal modification seeds may include at least one of MgAl₂O₄, CaCO₃, SrCO₃, SrTiO₃, BaCO₃, BaSO₄, BaTiO₃, Y₂O₃, TiO₂, TiC, ZrO₂, Cr₂O₃, Mn₂O₃, CuO, ZnO, B₂O₃, Al₂O₃, AlN, In₂O₃, SiO₂, SiC, SnO₂, Sb₂O₃, La₂O₃, CeO₂, Gd₂O₃, and MgF₂.

The crystal modification seeds may include at least one of Al₂O₃, TiO₂, SiO₂, and ZnO

The crystal modification seeds may have an average particle diameter of about 1 nm to about 200 nm.

The crystal modification seed layer may have a thickness of about 2 μm or less.

The crystal modification seed layer may cover only a part of the surface of the dielectric layer.

The crystal modification seed layer may cover a part of the dielectric layer corresponding to a display electrode, a gap between display electrodes, or a bus electrode.

The protective layer grains may include at least one of a fluoride and an oxide.

The protective layer grains may include at least one of MgO, SrCaO, 12CaO.7Al₂O₃, MgF₂, CaF₂, LiF, Al₂O₃, ZnO, CaO, SrO, SiO₂, TiO₂, and La₂O₃.

The protective layer may have a thickness of about 5000 Å to about 20,000 Å.

The protective layer grains may have an average grain diameter of about 10 nm to about 30 nm.

The protective layer grains in a region of the protective layer distal to the crystal modification seed layer may have a greater grain diameter than protective layer grains in a region of the protective layer proximal to the crystal modification seed layer.

The protective layer grains may have a 200 crystal plane.

The protective layer grains may have a 200 crystal plane in a region corresponding to the crystal modification seed layer, and a 111 crystal plane in a region of the dielectric layer not covered by the crystal modification seed layer.

At least one of the above and other features and advantages may also be realized by providing a plasma display panel including front and rear substrates arranged opposite to each other, a plurality of display electrodes disposed on one surface of the front substrate in one direction, a dielectric layer covering the display electrodes and formed on the front substrate, and a protective layer covering the dielectric layer and disposed at the top, wherein a crystal modification seed layer is disposed between the dielectric layer and the protective layer, and the crystal modification seed layer is formed corresponding to one selected from the group consisting of a display electrode, a gap between the display electrodes, and a bus electrode.

At least one of the above and other features and advantages may also be realized by providing a method of manufacturing a plasma display panel, including providing a front substrate and a rear substrate arranged opposite to each other, forming a plurality of display electrodes disposed in a first direction on a first surface of the front substrate, forming a dielectric layer covering the display electrodes on the front substrate, forming a protective layer including protective layer grains covering the dielectric layer, and forming a crystal modification seed layer disposed between the dielectric layer and the protective layer, wherein the crystal modification seed layer includes crystal modification seeds including at least one of an alkaline earth metal, a transition metal, an amphoteric element, a semimetal element, and a lanthanide.

The crystal modification seeds may include Al₂O₃.

The step of forming the crystal modification seed layer may include thick-layer printing or photo lithography, and the step of forming the protective layer may include a deposition.

The method may further include patterning the crystal modification seed layer to only cover a part of the dielectric layer, before forming the protective layer.

The crystal modification seed layer may be patterned to correspond to a display electrode, a gap between display electrodes, or a bus electrode.

The protective layer grains may have a 200 crystal plane in a region corresponding to the crystal modification seed layer, and a 111 crystal plane in a region of the dielectric layer not covered by the crystal modification seed layer.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a partial exploded perspective view of a PDP according to an embodiment;

FIG. 2A illustrates an image of grains of a MgO protective layer in a PDP prepared according to Comparative Example 1, where the MgO protective layer is formed on a dielectric layer;

FIG. 2B illustrates an image of grains of a MgO protective layer in a PDP prepared according to Example 1, where an Al₂O₃ crystal modification seed layer is disposed on a dielectric layer, and then the MgO protective layer is formed thereon;

FIG. 3A illustrates an image of a cross-section of the protective layer included in the PDP prepared according to Comparative Example 1;

FIG. 3B illustrates an image of a cross-section of the protective layer included in the PDP prepared according to Example 1;

FIG. 4 illustrates a graph showing an efficiency comparison of the PDPs prepared according to Example 1 and Comparative Example 1; and

FIG. 5 illustrates a graph showing the address discharge delay distribution of the PDPs prepared according to Example 1 and Comparative Example 1.

### DETAILED DESCRIPTION

Korean Patent Application No. 10-2008-0043951, filed on May 13, 2008, in the Korean Intellectual Property Office, and entitled: “Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a lanthanide” may represent a single compound, e.g., lanthanum, or multiple compounds in combination, e.g., lanthanum mixed with cerium.

Embodiments relate to a crystal modification seed layer and a protective layer of a PDP. In the PDP, a protective layer may play a role of preventing damage to a dielectric layer and an electrode under the dielectric layer due to, e.g., ion impact during discharge. Accordingly, the protective layer may have an influence on discharge characteristics, depending on its material and quality. In general, a protective layer in a conventional PDP may include MgO with excellent sputtering resistance and a high secondary electron emission coefficient. However, since MgO in a protective layer may have a low secondary electron emission coefficient due to, e.g., uniformity deterioration and the like according to its material characteristics, it may not effectively lower discharge voltage of a PDP. This may result in a less efficient PDP.

According to the embodiments, a PDP may have improved efficiency and discharge delay characteristics by controlling MgO protective layer growth with nanoparticles of a crystal modification seed inside a PDP cell. In other words, a PDP according to an embodiment may include a crystal modification seed layer including crystal modification seeds between the dielectric layer and the protective layer.

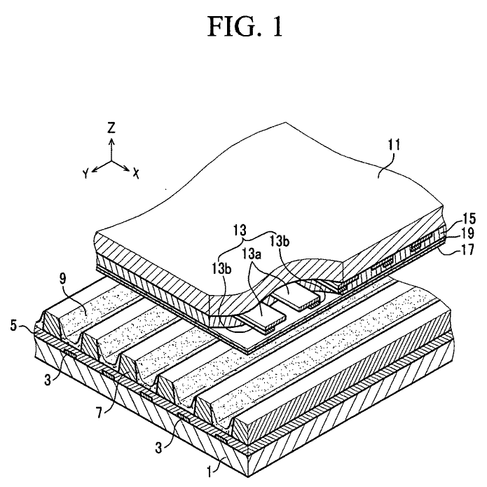

FIG. 1 illustrates a partial exploded perspective view of a PDP including the crystal modification seed layer. As shown in FIG. 1, the PDP may include a first substrate 1 (a rear substrate) and a second substrate 11 (a front substrate), which may be disposed in parallel each other, with a predetermined distance therebetween.

On the surface of the first substrate 1, a plurality of address electrodes 3 may be disposed in a first direction (the Y direction in the drawing), and a dielectric layer 5 may cover the address electrodes 3. A plurality of barrier ribs 7 may be formed on the dielectric layer 5 between the address electrodes 3 at a predetermined height to form discharge spaces. The barrier ribs 7 may be formed in any suitable shape of an open type or closed type as needed. Red (R), green (G), and blue (B) phosphor layers 9 may be disposed in discharge cells between the barrier ribs 7.

Display electrodes 13, each including a transparent electrode 13a and a bus electrode 13b, may be disposed in a second direction crossing the address electrodes 3 (an X direction in the drawing) on a surface of the second substrate 11 facing the first substrate 1. Also, a second dielectric layer 15 may be disposed on the surface of the second substrate 11, covering the display electrodes 13. A protective layer 17 may be disposed on the second dielectric layer 15.

The crystal modification seed layer 19 including crystal modification seeds may be disposed between the second dielectric layer 15 and the protective layer 17. The crystal modification seeds may control growth of protective layer grains, and thus improve discharge delay (Ts) characteristics.

The crystal modification seeds may have an average particle diameter similar to that of nanoparticles. In an embodiment, the crystal modification seeds may have an average particle diameter of about 1 nm to about 200 nm. Preferably, the crystal modification seeds have an average particle diameter of about 10 nm to about 30 nm. Maintaining the average particle diameter within the range of about 1 nm to about 200 nm may help ensure that the crystal modification seeds efficiently control growth of protective layer grains, and simultaneously form a thin layer, thereby minimally deteriorating visible light transmission.

The crystal modification seed may include at least one of an alkaline-earth metal, a transition metal, an amphoteric element, a semimetal element, and a lanthanide. In particular, the crystal modification seed may include a compound including, e.g., a carbonate salt, a sulfate, a carbide, a nitride, a fluoride, and/or an oxide including at least one of an alkaline-earth metal, a transition metal, an amphoteric element, a semimetal element, and/or a lanthanide. In particular, the crystal modification seed may include at least one of MgAl₂O₄, CaCO₃, SrCO₃, SrTiO₃, BaCO₃, BaSO₄, BaTiO₃, Y₂O₃, TiO₂, TiC, ZrO₂, Cr₂O₃, Mn₂O₃, CuO, ZnO, B₂O₃, Al₂O₃, AlN, In₂O₃, SiO₂, SiC, SnO₂, SB₂O₃, La₂O₃, CeO₂, Gd₂O₃, and MgF₂. Preferably, the crystal modification seed includes at least one of Al₂O₃, TiO₂, SiO₂, and ZnO.

The crystal modification seed layer 19 may have a thickness of about 2 μm or less. Preferably, the crystal modification seed layer 19 has a thickness of about 100 nm to about 2 μm. More preferably, the crystal modification seed layer 19 has a thickness of about 500 nm to about 1.5 μm. Maintaining the thickness at about 2 μm or less may help ensure that the transmittance rate is not severely deteriorated. Maintaining the thickness at about 2 μm or less may also help beneficially promote crystal growth for the protective layer 17.

The crystal modification seed layer 19 may completely, or at least partially, cover the dielectric layer 15, between the dielectric layer 15 and the protective layer 17. When the crystal modification seed layer 19 only partially covers the dielectric layer 15, it may be on the dielectric layer 15 in an area corresponding to, e.g., a display electrode, a gap between the display electrodes, or a bus electrode. In addition, the crystal modification seed layer 19 may somewhat overlap a bus electrode 13b and a transparent electrode 13a.

The protective layer 17 may prevent ions of an atom separated by plasma from colliding with and damaging the dielectric layer 15. The protective layer 17 may also help secondary electrons release smoothly when ions collide with one another.

The protective layer 17 may include protective layer grains formed by, e.g., deposition. The protective layer grains may have a larger grain diameter as the deposition progresses. That is, the protective layer grains in a region distal to the crystal modification seed layer 19 may have a larger grain diameter than the protective layer grains in a region proximal to, and at the interface with, the crystal modification seed layer 19.

The growth of the protective layer grains may be controlled by crystal modification seeds in the crystal modification seed layer 19. The protective layer may have a thickness of about 5000 Å to about 20,000 Å. The protective layer grains may have an average grain diameter of about 30 nm or less. Preferably, the protective layer grains have an average grain diameter of about 5 nm to about 30 nm. More preferably, the protective layer grains have an average grain diameter of about 10 nm to about 30 nm. Maintaining the average grain diameter at about 30 nm or less may help ensure that the protective layer grains have an influence on securing visible light transmittance, and directing crystal growth, thereby improving efficiency and discharge delay characteristics of a PDP.

The protective layer grains may include, e.g., a fluoride or an oxide. Preferably, the protective layer grains include at least one of MgO, SrCaO, 12CaO.7Al₂O₃, MgF₂, CaF₂, LiF, Al₂O₃, ZnO, CaO, SrO, SiO₂, and La₂O₃. The protective layer 17 may be formed as a single layer, two layers, or more than two layers. The protective layer grains may have various crystal planes of, e.g., 200, 100, 111, 110, or the like, depending on the material used, as determined by x-ray diffraction. The protective layer grains especially may have a 200 crystal plane which ensure an improvement of discharge delay characteristics.

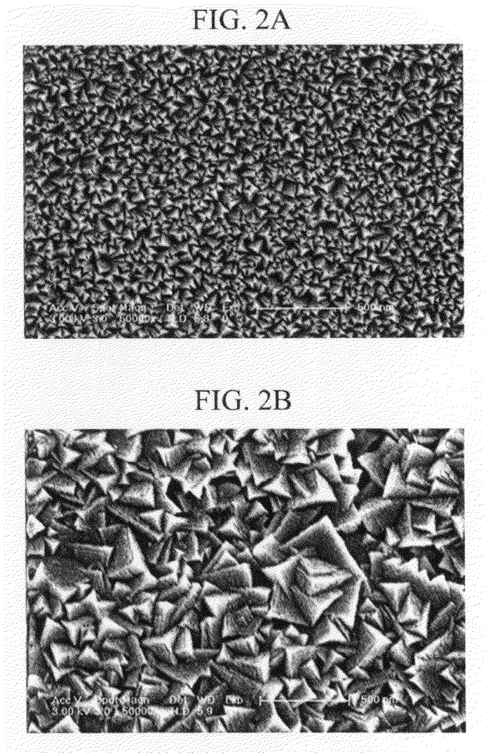

In addition, when the crystal modification seed layer 19 is formed on only part of the dielectric layer 15 by, e.g., patterning or printing, the protective layer 17 may include protective layer grains with different characteristics. Specifically, when a crystal modification seed layer 19 is formed on only part of the dielectric layer 15, a protective layer 17 with a 200 crystal plane may be formed on the crystal modification seed layer 19. A protective layer 17 having a 111 crystal plane may be formed on the dielectric layer 15 without a crystal modification seed layer 19. This may enable the protective layer to have excellent secondary electron-emitting capability and high sputtering resistance in a region without the crystal modification seed layer 19. Accordingly, a protective layer 17 may include protective layer grains with dual characteristics. As illustrated in FIG. 2A, a conventional MgO protective layer 17 may have a (111) plane. As illustrated in FIG. 2B, a protective layer 17 formed on a seed layer may have a (200) plane at a degree of 43°.

The protective layer 17 may have a thickness of about 5000 Å to about 10,000 Å. Maintaining the thickness of the protective layer 17 within this range may help ensure an appropriate balance between sputtering resistance and secondary electron releasing effects. In addition, a thickness ratio of the protective layer 17 to the crystal modification seed layer 19 may be about 0.2:1 to 1:2. Maintaining the thickness ratio within this range may help ensure a balance between discharge delay characteristic improvement and an increase in secondary electron releasing effects.

Accordingly, the PDP of an embodiment may have a lower capacitance value than a conventional PDP when a voltage is applied. As a result, the PDP of an embodiment may have a relatively low current value and only a slightly lower brightness than a conventional PDP, and may therefore have increased efficiency.

Since a method of manufacturing a general PDP is well-known and understood by one having ordinary skill in the art, it will not be illustrated in detail here. However, a process of forming a protective layer 17 and a crystal modification seed layer 19 is described in detail below.

The crystal modification seed layer 19 of an embodiment may be prepared by coating a paste including crystal modification seeds on the second substrate 11 having the dielectric layer 15 thereon. Specifically, a crystal modification seed layer 19 may be formed by coating a paste including crystal modification seeds on the dielectric layer 15 by, e.g., a thick-layer printing method, to cover the entire second dielectric layer 15, or at least a part thereof.

The paste may be prepared by mixing crystal modification seeds with a solvent. The solvent may include, e.g., dimethyl acetamide, dimethyl sulfoxide, N-methyl pyrrolidone, tetrahydrofuran, alcohols, propylene glycol monomethyl ether acetate (PGMEA), and the like. In addition, the paste may include an additive, e.g., an organic or inorganic binder, a dispersing agent, a leveling agent, and the like.

The paste may be coated on the dielectric layer 15 by a method including, e.g., screen printing, spray coating, doctor blade, gravure coating, dip coating, silk screening, painting, table-coating, spin-coating, slot die coating, or a photolithography process, depending on its viscosity. Preferably, the method of coating includes screen printing, table-coating, or spin-coating.

Next, the paste coated on the dielectric layer 15 may be dried using a conventional method including, e.g., natural drying, heating, and the like. The drying may be performed at a temperature of about 40° C. to about 120° C. for about 10 minutes or less. Preferably, the drying is performed for about 2 to about 5 minutes. The drying may be performed once or twice to enhance drying efficiency.

After the drying, the substrate having the paste may be fired at a temperature of about 370° C. to about 580° C. The firing may be performed for about 15 to about 30 minutes. The firing may also be performed once or twice.

Then, the crystal modification seed layer 19 may be patterned. The patterning process may be performed using a conventional patterning method.

The crystal modification seed layer 19 may be formed by coating and drying a dielectric layer slurry, and then coating, drying, and firing a crystal modification seed layer paste. In other words, firing a dielectric layer slurry coating layer and firing a crystal modification seed layer paste may be simultaneously performed

The protective layer 17 may then be formed by depositing and growing protective layer grains on the crystal modification seed layer 19 using, e.g., a deposition method. The deposition method for forming the protective layer 17 may include, e.g., electron beam deposition by using plasma, ion plating, magnetron sputtering, and the like.

When protective layer grains are deposited as in the above described deposition, they may have different crystal growth directions and layer quality, depending on the kinds of grains. Compared with a conventional MgO protective layer, the protective layer grains of an embodiment may have a larger grain crystal size and a crystal plane of 200, beneficially improving discharge delay characteristics.

In addition, when a crystal modification seed layer 19 is formed on only part of a dielectric layer 15 by, e.g., patterning or printing, protective layer grains with a 200 crystal plane may grow in a region corresponding to the crystal modification seed layer 19. Protective layer grains with a 111 crystal plane may grow on the part of the dielectric layer 15 not covered by the crystal modification seed layer 19. Accordingly, a protective layer 17 may include protective layer grains with dual characteristics. After deposition and growth of the protective layer grains, the substrate having the protective layer 17 may be aged.

When a protective layer 17 is formed using the deposition method described above, it may have improved electron releasing characteristics and decrease a discharge current. This may improve efficiency of a PDP as well as discharge delay characteristics, e.g., jitter.

The protective layer 17 may be coated on the first and second substrates 1 and 11 of a PDP and then sealed with frit. A discharge gas, e.g., Ne or Xe, may then be injected therein, fabricating a PDP.

When a driving voltage is applied to the PDP through the electrodes, an address discharge may be generated, forming a wall charge on a dielectric layer. A sustain discharge may be generated between the electrodes by AC signals supplied to the electrode pairs on the upper substrate inside discharge cells, which are selected by the address discharge. Accordingly, discharge gas charged in a discharge cells may be excited and transferred, generating ultraviolet (UV) rays. The ultraviolet (UV) rays may excite phosphors and thereby generate visible rays, realizing an image.

The following examples illustrate the embodiments in more detail. The following examples are not more than specific examples, and the scope is not limited by the examples.

### EXAMPLE 1

A display electrode was fabricated in a stripe shape by including an indium tin oxide (ITO) transparent electrode and a bus electrode on a front substrate made of soda lime glass using a conventional method. Next, a lead-based glass paste was coated on the front substrate having the display electrode thereon, and fired to prepare a dielectric layer.

Then, a slurry prepared by dispersing Al₂O₃ crystal modification seeds with an average particle diameter of 15 nm into propyleneglycol monomethyl ether acetate (PGMEA) solvent was coated on the dielectric layer using a thick-layer printing method. The slurry was dried at 120° C. for 10 minutes, and fired at 480° C. for 15 minutes, to form a crystal modification seed layer. Subsequently, MgO was deposited to cover the crystal modification seed layer using an electron beam deposition method to form a protective layer, completing an upper panel. The protective layer was formed under a vacuum of 1.0×10⁻⁷ Pa, and deposited under vacuum of 3×10⁻⁴ Pa. The substrate temperature was 200° C. and the layer formation speed was 20 Å/Sec. In addition, the crystal modification seed layer was 1.5 μm thick, and the protective layer was 8000 Å thick.

### EXAMPLE 2

A PDP was fabricated according to the same method as Example 1, except the crystal modification seed layer was patterned to correspond to a display electrode.

### EXAMPLE 3

A PDP was fabricated according to the same method as Example 1, except the crystal modification seed layer had a thickness of 500 nm, and used AlN crystal modification seeds with an average particle diameter of 10 nm.

### EXAMPLE 4

A PDP was fabricated according to the same method as Example 1, except the crystal modification seed layer had a thickness of 1.5 μm, and used TiO₂ crystal modification seeds with an average particle diameter of 30 nm.

### EXAMPLE 5

A PDP was fabricated according to the same method as Example 1, except SiC crystal modification seeds with an average particle diameter of 20 nm were used, and SiO₂ grains were used as protective layer grains.

### EXAMPLE 6

A PDP was fabricated according to the same method as Example 1, except ZnO crystal modification seeds with an average particle diameter of 15 nm were used, and Al₂O₃ grains were used as protective layer grains.

### COMPARATIVE EXAMPLE 1

A display electrode was fabricated in a stripe shape by forming an ITO transparent electrode and a bus electrode on a front substrate made of soda lime glass using a conventional method. Next, a dielectric layer was formed by coating a lead-based glass paste on the front substrate having the display electrode.

Then, MgO was deposited on the dielectric layer using an electron beam deposition method to form a protective layer, completing an upper panel. The protective layer was formed under a vacuum of 10×10⁻⁷ Pa, and the deposition was performed under a vacuum of 3×10⁻⁴ Pa. The substrate temperature was 200° C., and the layer formation speed was 20 Å/Sec. The protective layer was 8000 Å thick.

The PDPs prepared according Example 1 and Comparative Example 1 were examined regarding the grains inside the protective layer with a scanning electron microscope. The results are shown in FIGS. 2A and 2B.

FIG. 2A illustrates an image showing the grains of the MgO protective layer on the dielectric material in the PDP prepared according to Comparative Example 1. FIG. 2B illustrates an image of the MgO protective layer on the Al₂O₃ crystal seed modification layer formed on the dielectric layer in the PDP prepared according to Example 1.

As shown in FIGS. 2A and 2B, the protective layer on the crystal modification seed layer according to Example 1 turned out to have a remarkably increased size of grains, when compared with the protective layer prepared according to Comparative Example 1.

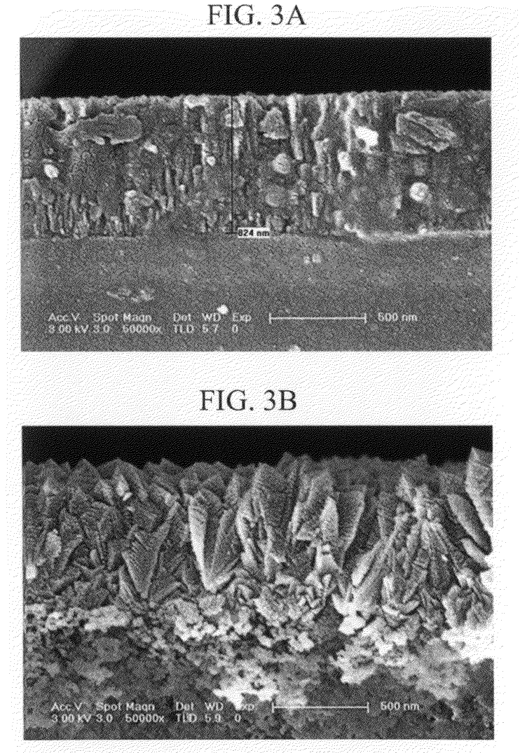

The PDPs prepared according to Example 1 and Comparative Example 1 were also examined with a scanning electron microscope regarding the cross-section of the protective layers. The results are illustrated in FIGS. 3A and 3B.

FIG. 3A illustrates an image of the cross-section of the protective layer in the PDP prepared according to Comparative Example 1. FIG. 3B illustrates an image of the cross-section of the protective layer in the PDP prepared according to Example 1.

As shown in FIGS. 3A and 3B, the protective layer on the crystal modification seed layer of Example 1 had larger grains than the protective layer of Comparative Example 1. The protective layer in the PDP prepared according to Example 1 also had a larger crystal cross-section moving further away from the crystal modification seed layer.

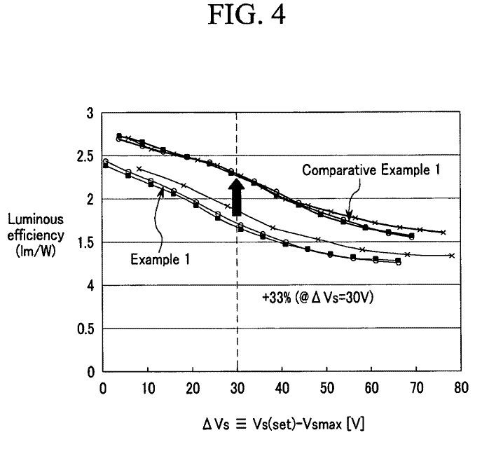

The PDPs of Example 1 and Comparative Example 1 were also evaluated for luminous efficiency. The luminous efficiency was evaluated by applying a pulse waveform of an operation driver to the panels, and then measured with a brightness meter and a current tester. The results are shown in FIG. 4.

As shown in FIG. 4, the PDP prepared according to Example 1 had 33% increased luminous efficiency when compared with the PDP prepared according to Comparative Example 1.

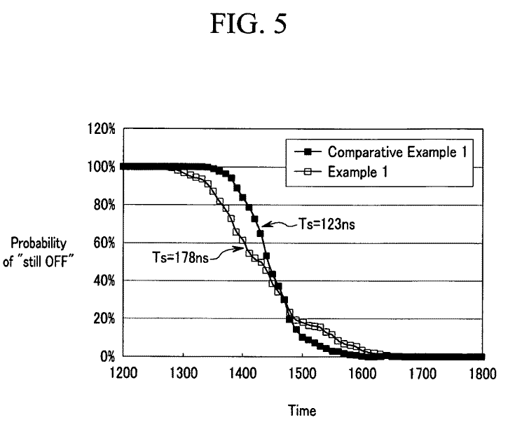

The PDPs of Example 1 and Comparative Example 1 were also measured for the probability of “still OFF” at times from scan input (applying a pulse at an addressing period) thereof, and then measured using an oscilloscope and a photoprobe. Then, the address discharge delay distributions were evaluated. The results are shown in FIG. 5.

FIG. 5 illustrates a graph showing the entire delay distribution comparison of the PDPs prepared according to Example 1 and Comparative Example 1. In FIG. 5, Ts indicates the address discharge delay distribution.

As shown in FIG. 5, the panel including a protective layer including MgO on a crystal modification seed layer including Al₂O₃ according to Example 1 had about 30% improved Ts when compared with the PDP prepared according to Comparative Example 1. Therefore, the panel of Example 1 may be said to have an improved discharge delay characteristic.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a front substrate and a rear substrate arranged opposite to each other;
a plurality of display electrodes disposed in a first direction on a first surface of the front substrate;
a dielectric layer covering the display electrodes on the front substrate;
a protective layer including protective layer grains covering the dielectric layer; and
a crystal modification seed layer disposed between the dielectric layer and the protective layer, wherein the crystal modification seed layer includes crystal modification seeds including at least one of an alkaline earth metal, a transition metal, an amphoteric element, a semimetal element, and a lanthanide.

2. The plasma display panel as claimed in claim 1, wherein the crystal modification seeds include at least one of:
a carbonate salt of at least one of an alkaline earth metal, a transition metal, an amphoteric element, a semimetal element, and a lanthanide;
a sulfate of at least one of an alkaline earth metal, a transition metal, an amphoteric element, a semimetal element, and a lanthanide;
a carbide of at least one of an alkaline earth metal, a transition metal, an amphoteric element, a semimetal element, and a lanthanide;
a nitride of at least one of an alkaline earth metal, a transition metal, an amphoteric element, a semimetal element, and a lanthanide;
a fluoride of at least one of an alkaline earth metal, a transition metal, an amphoteric element, a semimetal element, and a lanthanide; or
an oxide of at least one of an alkaline earth metal, a transition metal, an amphoteric element, a semimetal element, and a lanthanide.

3. The plasma display panel as claimed in claim 2, wherein the crystal modification seeds include at least one of MgAl₂O₄, CaCO₃, SrCO₃, SrTiO₃, BaCO₃, BaSO₄, BaTiO₃, Y₂O₃, TiO₂, TiC, ZrO₂, Cr₂O₃, Mn₂O₃, CuO, ZnO, B₂O₃, Al₂O₃, AlN, In₂O₃, SiO₂, SiC, SnO₂, Sb₂O₃, La₂O₃, CeO₂, Gd₂O₃, and MgF₂.

4. The plasma display panel as claimed in claim 3, wherein the crystal modification seeds include at least one of Al₂O₃, TiO₂, SiO₂, and ZnO.

5. The plasma display panel as claimed in claim 1, wherein the crystal modification seeds have an average particle diameter of about 1 nm to about 200 nm.

6. The plasma display panel as claimed in claim 1, wherein the crystal modification seed layer has a thickness of about 2 μm or less.

7. The plasma display panel as claimed in claim 1, wherein the crystal modification seed layer covers only a part of the surface of the dielectric layer.

8. The plasma display panel as claimed in claim 7, wherein the crystal modification seed layer covers a part of the dielectric layer corresponding to a display electrode, a gap between display electrodes, or a bus electrode.

9. The plasma display panel as claimed in claim 1, wherein the protective layer grains include at least one of a fluoride and an oxide.

10. The plasma display panel as claimed in claim 9, wherein the protective layer grains include at least one of MgO, SrCaO, 12CaO.7Al₂O₃, MgF₂, CaF₂, LiF, Al₂O₃, ZnO, CaO, SrO, SiO₂, TiO₂, and La₂O₃.

11. The plasma display panel as claimed in claim 1, wherein the protective layer has a thickness of about 5000 Å to about 20,000 Å.

12. The plasma display panel as claimed in claim 1, wherein protective layer grains in a region of the protective layer distal to the crystal modification seed layer have a greater grain diameter than protective layer grains in a region of the protective layer proximal to the crystal modification seed layer.

13. The plasma display panel as claimed in claim 1, wherein the protective layer grains have a 200 crystal plane.

14. The plasma display panel as claimed in claim 13, wherein the protective layer grains have a 200 crystal plane in a region corresponding to the crystal modification seed layer, and a 111 crystal plane in a region of the dielectric layer not covered by the crystal modification seed layer.

15. A plasma display panel, comprising:
front and rear substrates arranged opposite to each other;
a plurality of display electrodes disposed on one surface of the front substrate in one direction;
a dielectric layer covering the display electrodes and formed on the front substrate; and
a protective layer covering the dielectric layer and disposed at the top,
wherein a crystal modification seed layer is disposed between the dielectric layer and the protective layer, and
the crystal modification seed layer is formed corresponding to one selected from the group consisting of a display electrode, a gap between the display electrodes, and a bus electrode.
